(19) United States
(12) Patent Application Publication
(10) Pub. No.: US 2006/0101012 A1
(43) Pub. Date: May 11, 2006

(54) Search system presenting active abstracts including linked terms

(76) Inventors: Chad Carson, Redwood City, CA (US); Douglas Michael Cook, San Franciso, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 11/150,045

(22) Filed: Jun. 10, 2005

Related U.S. Application Data
(60) Provisional application No. 60/627,254, filed on Nov. 11, 2004.
(60) Provisional application No. 60/627,189, filed on Nov. 11, 2004.

(51) Int. Cl. G06F 7/00; G06F 17/30

(52) U.S. Cl. 707/4

(57) ABSTRACT

Upon receiving a search query, a search to identify at least one resource relevant to the search query is performed. At least one excerpt is extracted from the at least one resource, and a term of interest is identified in the excerpt. A link to a referral document is associated with the term of interest. Upon selection of the link, the referral document is displayed. Alternatively, the link is associated with a second search query, and the second search query is automatically performed upon selection of the link. A network telephone call can be automatically placed when a telephone number is the term of interest.

### CROSS-REFERENCES TO RELATED APPLICATIONS

This application is a non-provisional application of and claims the benefit of priority from U.S. Provisional Application Nos. 60/627,254, filed on Nov. 11, 2004, entitled “SEARCH SYSTEM PRESENTING ACTIVE ABSTRACTS INCLUDING LINKED TERMS” and 60/627,189, filed on Nov. 11, 2004, entitled “DOCUMENT NAVIGATION BY ACTIVE ABSTRACTS”; the entire content of which is incorporated by these references for all purposes as if fully disclosed herein. The present disclosure is related to commonly-assigned co-pending U.S. application No. (Attorney Docket No. 50269-0642), filed on the same date as the present application, entitled “DOCUMENT NAVIGATION BY ACTIVE ABSTRACTS,” which disclosure is incorporated herein by reference for all purposes

### FIELD OF THE INVENTION

The present invention relates to methods and apparatus for searching a document corpus, and more particularly relates to providing abstracts with links for launching related searches in search results.

### BACKGROUND

A search engine is a computer program that helps a user to locate information. To locate information on a particular topic, a user can submit to a search engine one or more search query terms related to the topic. In response, the search engine executes the search query and generates information about the results of the search. The information about the results of the search, referred to herein as the “search results”, usually includes a list of the resources, such as documents, files, webpages, etc., that satisfy the search query. The resources identified in the search results are referred to herein as “matching resources”.

While search engines may be applied in a variety of contexts, one common use is navigating through document corpuses by searching for documents of interest. Therefore, search engines are especially useful for locating resources that are accessible through the Internet, as the Internet can be thought of as a large set of resources. Many various searching techniques may be used by Internet search engines. For example, an Internet search engine might read or “crawl” pages on the Internet to create entries for a search index, and then use that index when determining which pages are relevant to a search query.

Matching resources identified in Internet search results may include files whose content is composed in a page description language such as Hypertext Markup Language (HTML). Such files are typically called webpages. Using a web browser, a webpage may be retrieved by entering its Universal Resource Locator (URL) in the browser. Internet search results may therefore be presented to a user as a list of hypertext links to the URLs of matching resources. Users retrieve a document or resource of interest found in a search by selecting the resource's hypertext link or URL found in the search results.

Search results may contain so many matching resources that a user may be overwhelmed. In order to assist the user, search results frequently include a short description or “abstract” with each matching resource. Abstracts are relatively short, so that a user may quickly judge the relevance of a matching resource listed in the search results.

Frequently, an abstract for a matching resource is comprised of an excerpt related to the search query taken from the matching resource. For example, an excerpt may comprise a section of the matching resource that includes one or more query terms from the search query, or a section that includes information relevant to a query term. The goal of presenting search results as a series of excerpt-based abstracts is to help the user decide which matching resources include information the user is seeking. By reading the excerpt taken from a given matching resource, a user should be able to better determine whether a matching resource merits further investigation.

Searching for a particular resource is often a multi-step process, as search results generated by a search engine, while relevant to the query, might not include the precise information the searcher desires, and therefore further searches may be needed. Frequently, the searcher subsequently makes another search query based on information obtained from the results of the initial search.

For instance, a user may initiate a search query by typing or cutting-and-pasting one or more query terms into the search window of a webpage that is published by a search engine, such as the Yahoo! Search server. Depending on the query terms used and the number of pages or documents that contain those query terms, search results may contain many matching resources. The user then selects certain matching resources in the search results to investigate further in order to find a particular resource.

As a specific example, a searcher who is looking for driving directions to a location (e.g., a museum), might enter the name of the location (i.e., search query) into a search engine interface, and receive search results comprised of a list of matching resources that contain the name of the entered location. While the search results from the initial query might be salient as to the location, the search results might not include driving directions to the location, which is the information actually desired by the user. However, the search results may include an address or other information that could be used in another search to obtain the desired driving directions. For example, the searcher might cut-and-paste the address for the location determined in the initial search into a mapping search engine (e.g., Yahoo! Map server) that is configured to search a map database to generate driving directions to a location.

While this example provides the user with the desired information with two search queries, in many cases a larger number of search queries are needed to find the desired information. Accordingly, these traditional search techniques tend to be slow and tedious as a user must manually (e.g., typing or cutting-and-pasting query terms) execute each search individually in order to locate desired information or a particular resource.

Better techniques for providing search results from a search engine are needed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a simplified schematic diagram of an information retrieval and communication network including a client system according to an embodiment of the present invention;

FIG. 2 is an illustration of an exemplary browser showing an exemplary search-engine webpage that might be served to a client system at the request of a user according to an embodiment of the present invention;

FIG. 3 is an illustration of an exemplary browser showing an exemplary search-engine webpage that includes a query term entered on the webpage according to an embodiment of the present invention;

FIG. 4 is an illustration of an exemplary browser showing a webpage that provides search results to a client system according to an embodiment of the present invention;

FIG. 5A is a simplified illustration of an exemplary document, such as a webpage, that is included in a document corpus to be searched;

FIG. 5B is a simplified illustration of the exemplary document of FIG. 5A having an anchor disposed therein that is the target of a link presented in the search results;

FIG. 6 is a high-level flow chart having steps for launching a search using an active abstract according to an embodiment of the present invention;

FIG. 7 is a high-level flow chart having steps for launching a search using an active abstract according to another embodiment of the present invention; and

FIG. 8 is a block diagram that illustrates a computer system upon which an embodiment of the invention may be implemented.

### DESCRIPTION OF SPECIFIC EMBODIMENTS

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

While the present invention is described with reference to searching the Internet, it should be understood that references to the Internet can be substituted with references to variations of the basic concept of the Internet (e.g., intranets, virtual private networks, enclosed TCP/IP networks, LAN, WAN, etc.) as well as other forms of networks. It should also be understood that the present invention might operate entirely within one computer or one collection of computers, thus obviating the need for a network.

In addition, protocols other than HyperText Transfer Protocol (HTTP) and URL might be used to request and transmit content from search results, such as SMTP (Simple Mail Transfer Protocol), FTP (File Transfer Protocol), etc.

Search Engine System Overview

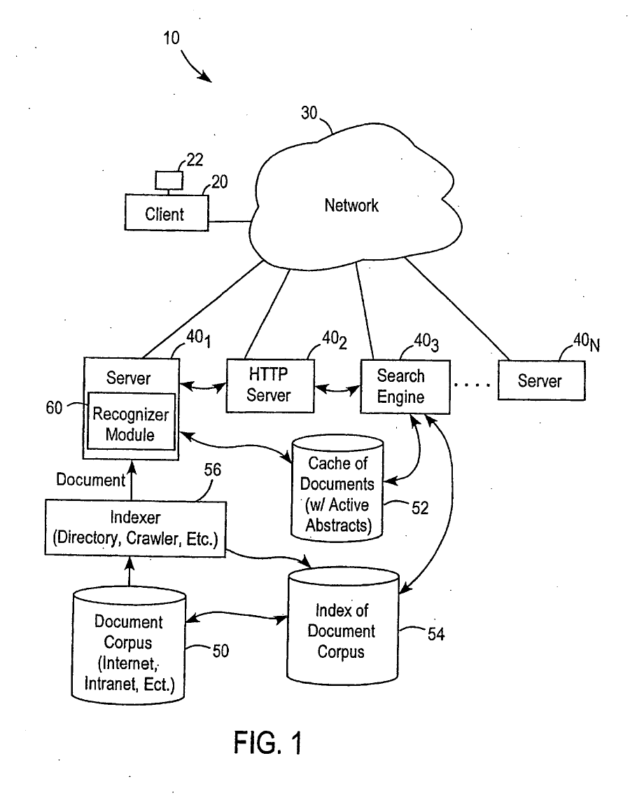

FIG. 1 is a simplified schematic of an information retrieval and communication network 10 including a client system 20 according to an embodiment of the present invention. In communication network 10, client system 20 is coupled through a network 30, such as the Internet or an intranet (e.g., a LAN or WAN), to any number of server systems 40₁-40_{N}. Client system 20 is configured to communicate with any of the server systems 40₁-40_{N} to access, receive, retrieve, and/or display matching resources served by one or more of the server systems. Client system 20 may communicate directly with a server system, or may communicate via network 30.

Client system 20 might include a desktop personal computer, a workstation, a laptop, a PDA (personal digital assistant), a cell phone, any wireless application protocol (WAP) enabled device or any other computing device capable of interfacing directly or indirectly to a searchable document corpus available over a network, such as the Internet.

Client system 20 typically runs a browser program, such as Microsoft's Internet Explorer™ browser, Netscape's Navigator™ browser, Mozilla™ browser, Opera™ browser, a WAP-enabled browser in the case of a cell phone, PDA or other wireless device, or the like, allowing a user of client system 20 to access, process, and view content from server systems 40₁ 40_{N} over network 30. The client system might also use less interactive interfaces, such as computer-to-computer eXtensible Markup Language (XML) interfaces or the like.

Client system 20 also typically includes one or more user interface devices 22 that might include one or more of a keyboard, a mouse, a roller ball, a touch screen, a touch pad, a pen or the like, for interacting with a graphical user interface (GUI) provided by the browser on a display (e.g., monitor screen, LCD display, etc.), in conjunction with pages, forms and other information provided by server systems 40₁-40_{N} or other servers.

Server systems 40₁-40_{N} are configured to provide one or more resources from search results to client system 20. Each server system may include a single server computer, or a cluster of server computers. In addition, a server system may be configured to operate as a search engine. For example, server system 40₃ might be configured to operate as an Internet search engine that receives a search query from client system 20 and provides search results to the client system. For convenience, server system 40₃ is referred to herein as a search engine. It should be understood that while server system 40₃ is referred to as a search engine, it may be configured to perform other functions to provide a broader utility than searching.

Client system 20 communicates a search query to a search engine. A search query includes one or more query elements, such as query terms (i.e., text strings), boolean operators, graphic elements (e.g., video elements, picture elements, etc.), audio elements or the like. While the invention is described in the context of a search query comprised of one or more query terms, it should be understood that search queries are not limited to query terms, and may include any type of query element.

A document is relevant to a search query if the document contains one or more query terms of the search query, contains a derivative of a query term, or otherwise includes information that is associated with a query term. A derivative of a query term might include the query term with a prefix or suffix added to the query term, might be a compound word that includes the query term or the like.

According to one embodiment, document corpus 50 includes documents that are on the world wide web (WWW), other networks (e.g., intranets), a single computer or the like. An optional indexer 56 is configured to form index 54 that indexes the documents in document corpus 50 and/or the documents in document cache 52. Indexer 56 may be configured to periodically electronically review (e.g., via a directory search, crawling, etc.) documents to form and/or update the index. Index 54 provides an index to the document corpus and/or document cache for quicker searching; however an index is not required. While indexer 56, document cache 52, and index 54 are shown in FIG. 1 as being separate from server systems 40₁-40_{N,} one or more of these components might alternatively be integral to one or more of the server systems.

According to one embodiment, search engine 403 searches a document corpus 50, document cache 52, and/or an index 54 for resources that are relevant to the search query submitted by client system 20. Any searching technique known to those skilled in the art may be used by the search engine 40₃.

Search results include information about the documents, or other resources, that are determined to be relevant to a search query (i.e., the matching resources). For example, search results might include a title, abstract, category and/or one or more keywords for each relevant document found in a search. Search results may also include links to the documents, links to cached versions of documents or other relevant information. A link included in the search results typically comprises a hypertext link to a specific URL.

As described briefly above, one or more of server systems 40₁-40_{N} may be configured to operate as a search engine (e.g., search engine 40₃) that receives a search query from a user via client system 20, performs a search based on the query terms in the search query, and provides search results to client system 20. The user of client system 20 can be a human user interacting with a user interface 22 of a client system 20 that processes the search query for transmission to search engine 40₃. The user could also be a computer process or system that generates the search query programmatically. In the latter instance, it is likely that the requesting process or system will also programmatically process the results of the search query, however alternatively a computer process or system may make a search query, and a human user is the ultimate recipient of the search results of the search query.

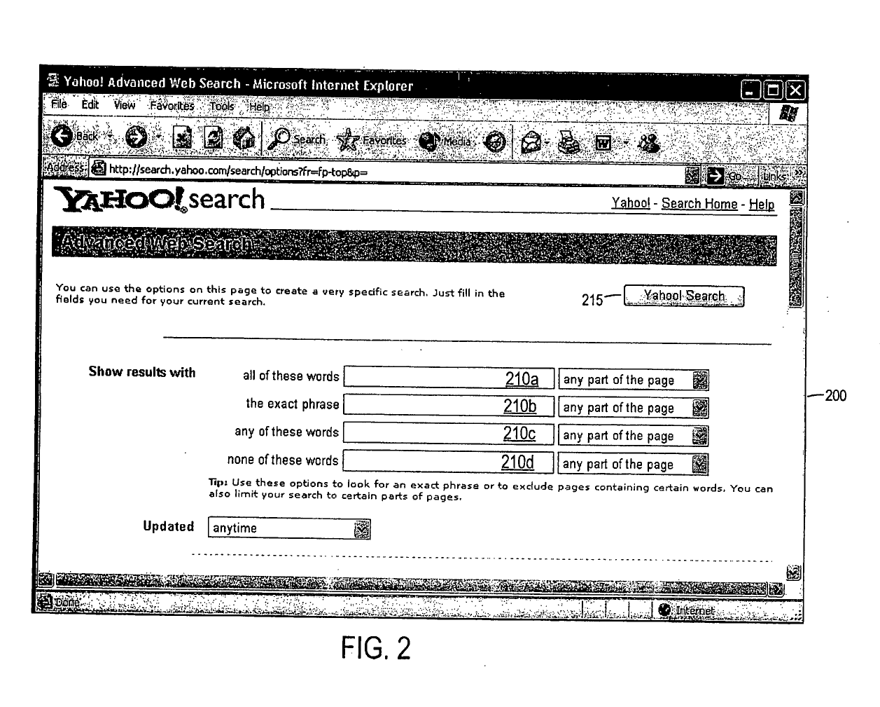

FIG. 2 is an illustration of an exemplary browser displaying an exemplary search engine webpage 200 that might be served to client system 20 by search engine 40₃. For example, search engine 40₃ might be configured to publish a search engine webpage on a website accessible through a URL. The search engine webpage is served to the client system when the user enters or otherwise selects the URL of the search engine's website in the browser. As a specific example, search engine webpage 200 may be the Yahoo! Search webpage, accessible via HTTP using the URL “www.yahoo.com.”

A user using a keyboard, for example, enters one or more query terms, i.e. text strings, in one or more boxes 210a-210d on the search engine webpage to form a search query. Alternatively, a query term might be cut and pasted into one or more of the boxes using a mouse or the like. Those of skill in the art will know of other techniques for entering query terms into a user interface of an application. It is noted that the search engine webpage is not limited to the entry of query terms, as a query might include other query elements, such as graphic elements (e.g., video elements, picture elements, etc.), audio elements or the like.

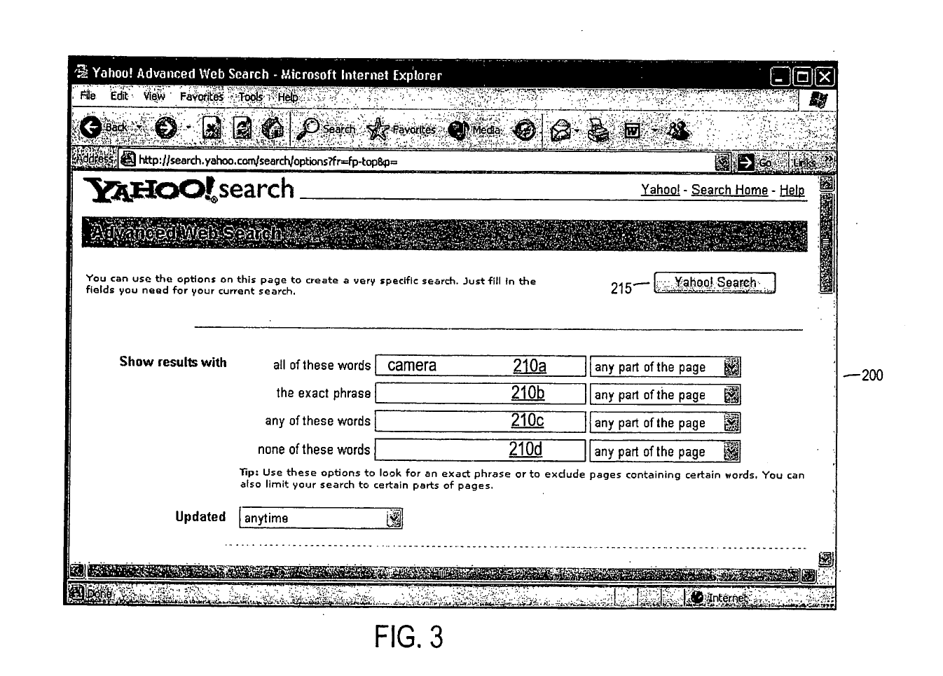

The user presses search button 215 to initiate a search for resources matching or relevant to entered query terms. For example, as shown in FIG. 3, a user might enter the string “camera” in box 210a and press search button 215 to initiate a search for documents that are relevant to the query term “camera.” Upon selection of the search button 215, the search query entered by the user is transferred from client system 20 to search engine 40₃ to initiate a search of document corpus 50, document cache 52, and/or index 54.

According to one embodiment, search engine 40₃ transmits the search query to document corpus 50, document cache 52, or index 54 in an HTTP message or the like. In response to receiving a query message from search engine 40₃, the document corpus and/or the document cache might perform a database search for resources (e.g., webpages) that match or are relevant to the search query. Further, if the index receives a query from the search engine, the index might search for documents that have been indexed to locate one or more documents that match or are relevant to the query.

In one embodiment, information about resources that are identified as matching or being relevant to the search query is transmitted from the document corpus or the document cache directly to search engine 40₃. Alternatively, information about matching resources is first transmitted to recognizer module 60, shown as a component of server system 40₁ in FIG. 1. Recognizer module 60 is used to extract or determine additional information about the identified matching resources. According to one embodiment, recognizer module 60 is configured to parse information received from document corpus 56 or document cache 52 to generate the search results that are served to client system 20. In one embodiment, the generated search results may be transferred to the client system via an HTTP server 40₂. Specific functionality of recognizer module 60 is discussed in detail below.

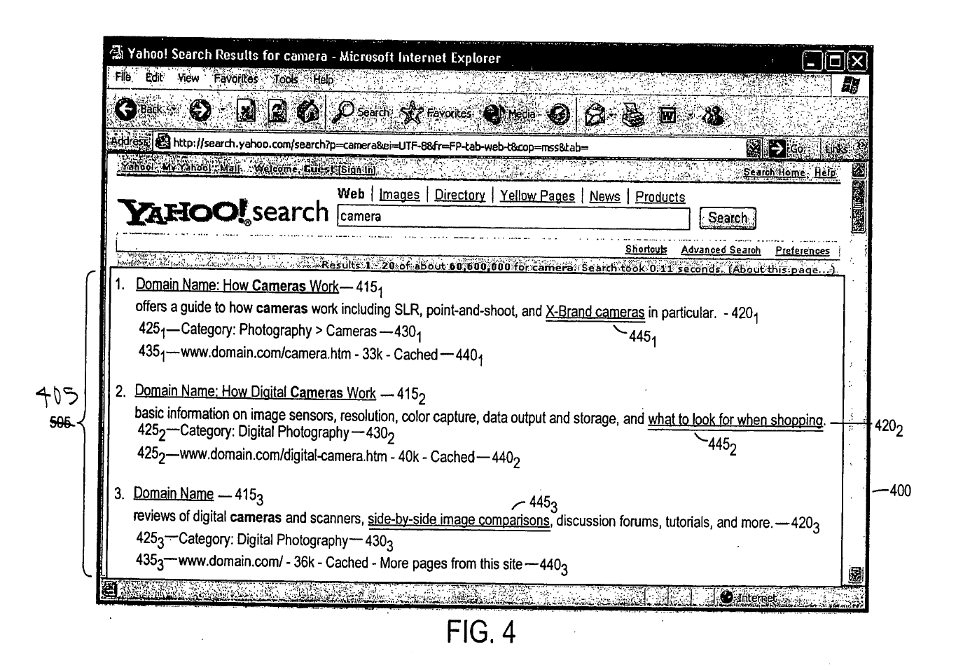

FIG. 4 is an illustration of an exemplary browser display showing an exemplary webpage 400 that includes search results 405 that might be served to client system 20 according to one embodiment of the present invention. The search results 405, according to the illustrative example being considered, includes three matching resources for the query term “camera” and are numbered from one to three. It should be understood that while webpage 400 includes three matching resources, search results might include fewer or more matching resources. According to some embodiments, search results might indicate that no resources were located that match the query.

Each matching resource in the search results may include a title 415, an abstract 420, a category 425 (such as a Yahoo! category used to categorize and organize web content), one or more subcategories 430, a link 435 to the associated resource, and a link 440 to a cached version of the resource. In one embodiment, link 430 and/or link 440 comprises a listing of an associated URL that can be cut-and-pasted into a browser. In one embodiment, link 430 and/or 435 comprises a hypertext link. The foregoing elements of the published search results are labeled in FIG. 4 with the above listed base reference numerals and numerical subscripts. Each matching resource in the search results may include one or more of the foregoing elements according to various embodiments of the present invention, and may include other elements not listed.

According to one embodiment, a title 415 included in search results may be extracted by recognizer module 60 from metadata associated with a matching resource. Alternatively, a title might be generated by the recognizer module, or another module. The recognizer module might be configured to transfer extracted or generated titles and the like to search engine 40₃.

In one embodiment, each title presented in the search results includes a link to its associated resource. The link might include the URL listed as link 435 or 440 as the target of the link. The association between the title and a link may be made by the search engine or by the recognizer module. A user may select a link associated with a title, and thus be linked to the associated resource, by clicking on the title, double-clicking on the title, or otherwise selecting the title.

Each category 425 and subcategory 430 might similarly be associated with selectable links. Category or subcategory links are typically configured to initiate the publication of a list of resources associated with the selected category and subcategory to the client system upon selection. The resources listed upon selection of a category link may also be associated with links. For example, the list of resources for a selected category may be listed by title, each title including a link to the associated resource.

Active Abstracts

According to one embodiment, each abstract 420 associated with a matching resource in the search results includes one or more excerpts from the associated resource. As used herein, an “excerpt” refers to a section of text, or other content, extracted from a resource. Preferably, an excerpt that is included in an abstract includes a query term used in the search query.

In one embodiment, recognizer module 60 is configured to identify excerpts for inclusion in an abstract. In one embodiment, recognizer module 60 may extract the first excerpt from a document that includes a query term or is otherwise related to the query term. In another embodiment, the recognizer module determines the relative relevance of excerpts, and selects excerpts with the highest determined relevance for inclusion in an abstract. For example, recognizer module 60 may be configured to determine which excerpts have a relatively high relevance to a query term. An excerpt might have a relatively high relevance to a query term if the excerpt includes the query term or includes a derivative of the query term, whereas an excerpt that does not include the query term or a derivative thereof, but includes terms related to the query term might have relatively low relevance. In one embodiment, the recognizer module selects one or more excerpts that are of relatively high relevance to the query term for use in an abstract. Those of skill in the art will know of other methods for identifying excerpts in a document for inclusion in an abstract.

According to one embodiment, recognizer module 60 is further configured to identify certain terms in an excerpt for which a user may desire additional information. In general, these terms are called “terms of interest.” A term of interest may include a single word, or it may include a string of words. For example, the recognizer module may recognize keywords, categories (e.g., Yahoo! defined keywords and categories), names (e.g., proper names, business names, organization names, place names, etc), uncommon words, the names of products, trademarks, service marks, titles (e.g., music titles, book titles, titles of television shows, etc.), street addresses, telephone numbers, etc., as being terms of interest. These are all types of terms that are likely to be used by a user in a secondary search for information.

In one embodiment, a term may be determined to be of interest according to user-specific preferences. User preferences can be determined from information provided by a user in a registration form, for example, or by tracking the user's queries and/or documents the user requests.

In one embodiment, one or more terms of interest identified in an excerpt are presented in an abstract in a conspicuous manner to indicate to the user that the term has been identified as being of potential interest to the user. For example, to conspicuously indicate a term is potentially of interest, the term might be bolded, underlined, double underlined, italicized, colored or like. For example, each of the abstracts 420 shown in FIG. 4 includes double underlined terms 445 to indicate that the terms are terms of interest. As shown in FIG. 4, the terms “X-brand cameras,” “what to look for when shopping,” and “side-by-side image comparison” have been double underlined in abstracts 420₁₋₃ to indicate that these terms may be of interest to the user. Terms of interest may also be identified by other techniques, such as configuring a cursor to change from a first graphic (e.g., an arrow) to a second graphic (e.g., a hand with a pointing finger) if the cursor is positioned over the term of interest. Those of skill in the art will recognize other useful techniques for indicating that a term in an excerpt is a term of interest.

A term of interest 445 may be configured to be an “active term.” An active term is a term that is associated with a link selectable by a user, such as a hypertext link. A user can select an active term to obtain additional information about the term, or about the abstract. Selection of an active term can result in various actions, some of which are described herein. The type of action that is associated with an active term can be determined by the term itself, in one embodiment.

In one embodiment, a link for an active term may be associated with a URL that identifies a specific document. In this embodiment, the document is downloaded and presented to the user in the browser when the user selects (e.g., clicks on) the active term. Typically, the specific document associated with an active term includes additional information about the term.

According to an alternative embodiment, a link associated with an active term may be configured to automatically launch another search that uses one or more words of the term of interest as query terms. More specifically, in this embodiment, selecting the link associated with the active term may trigger the term of interest (or select words therefrom) to be transmitted to search engine 40₃ to automatically launch a search for one or more resources that are relevant to the term of interest.

For example, search engine 40₃ might search document corpus 50, or search a network in real time, to locate resources that are relevant to the selected term of interest. Searches launched by selecting a link associated with an active term 445 are not so limited, however. For example, selecting a link associated with an active term may trigger a map server (e.g., the Yahoo! Map server) to automatically launch a map search to locate a map and/or driving directions to an address, a place, or the like that are included in the selected term of interest.

Alternatively, selecting a link associated with an active term may trigger an electronic dictionary (e.g., a web-based dictionary) to search for a definition of an uncommon word that is included in the selected term of interest. According to yet another alternative, selection of an active term causes an electronic encyclopedia to be searched, and a tutorial associated with the selected term of interest found in the encyclopedia to be presented to the user. According to yet another alternative, selecting a link associated with an active term may trigger an automatic search of a company website to find information, for example, for a product, a service or the like, identified in the selected term of interest. According to yet another alternative, selecting a link associated with an active term may automatically trigger a search of an intranet to locate information relevant to the selected term of interest.

According to yet another embodiment, a link associated with an active term may point to a cached version of the associated document in the document cache. In this embodiment, the recognizer module (or other module) may insert one or more anchors in the cached document such that the link associated with the active term points to the anchor within the cached document.

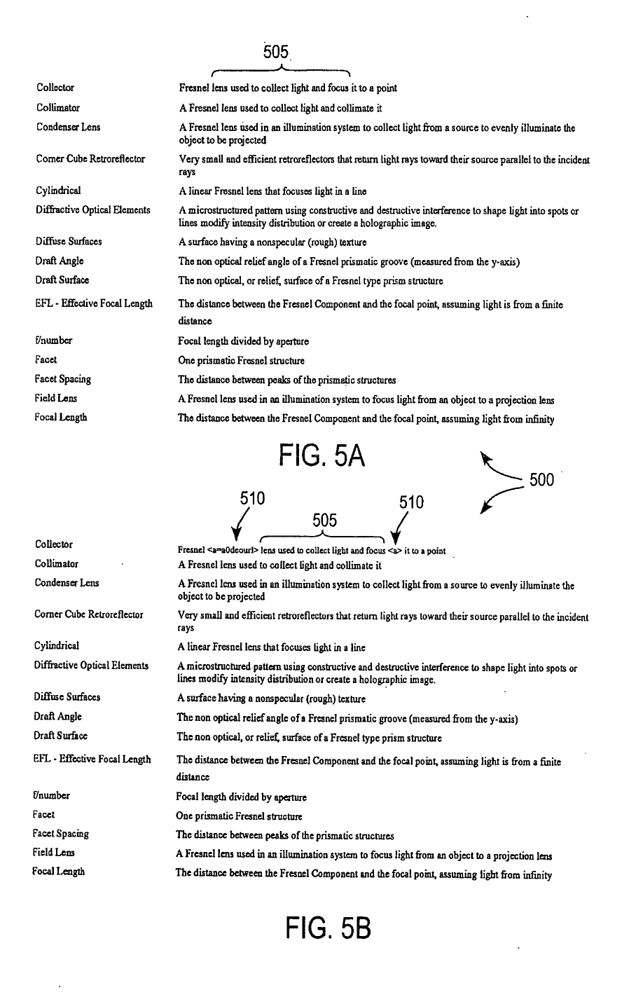

For example, FIG. 5A illustrates a simplified illustration of a document 500 (e.g., a webpage) that might be in the document corpus. A portion 505 of the document might be an excerpt that is extracted by recognizer module 60 for presentation in search results, such as in an abstract. FIG. 5B shows a version of document 500 that might be stored in the document cache. The recognizer module inserts an anchor 510 in the document that is associated with the term of interest in the abstract. The anchor is disposed around the portion of text 505 such that if the associated active term is selected, the cached document is displayed in a browser window on the client system starting at the anchored portion of text 505. The anchor might be implemented suing HTML, XHTML, SGML, XML or the like. According to some embodiments, recognizer module 60 might be configured to cache documents in the document cache prior to a search being performed by a user.

In alternative embodiments, the recognizer module may insert anchors into cached versions of documents at the beginning of a document, or at other locations of the document. For example, the recognizer module might be configured to insert anchors in cached documents around strings that might be included in popular queries (e.g., queries that are executed more than a predetermined or configured number of times).

According to still another alternative, a web-based telephone call (e.g., voice over IP telephone call) might be launched if an active term includes a telephone number. For example, if in an initial network search using search engine webpage 200, a user searches for a company by name, and the search results of the initial network search include an excerpt from a web page that includes a telephone number for the company, the user might cause a network telephone call to the company to be automatically placed by selecting (e.g., clicking on) the telephone number displayed as an active term in the abstract.

While a number of illustrative examples have been described for the use of links associated with active terms in an excerpt-based abstract, those of skill in the art will recognize other searches or services that might be initiated from the selection of a link associated with an active term.

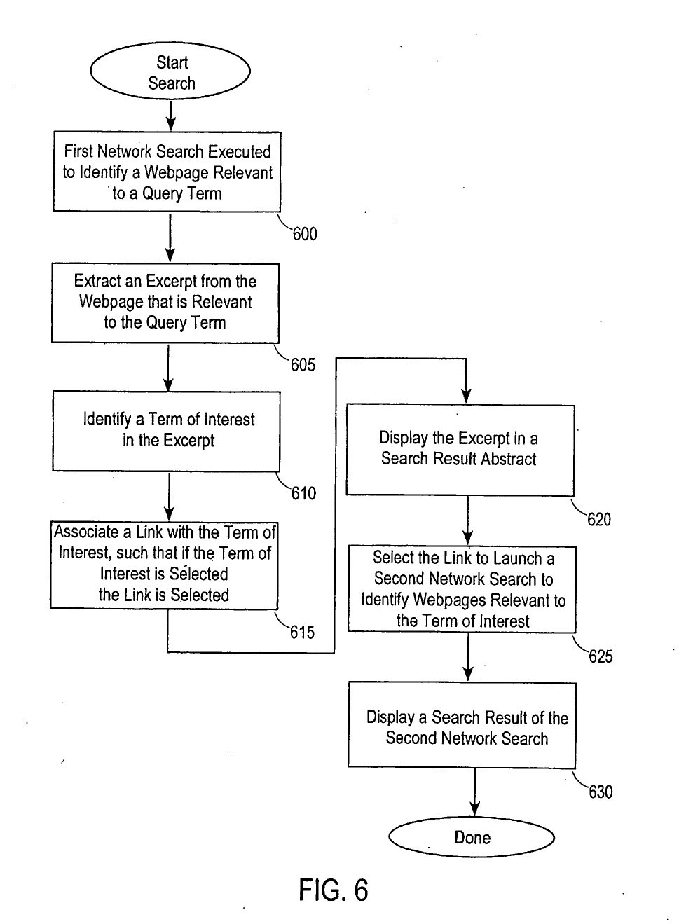

FIG. 6 is a high-level flow chart having steps for initiating a search using an active abstract. The high-level flow chart is merely exemplary, and those of skill in the art will recognize various steps that might be added, deleted, and/or modified and are considered to be within the purview of the present invention. Therefore, the exemplary embodiment should not be viewed as limiting the invention as defined by the claims.

At 600, a first network search is performed to identify at least one resource relevant to a query term. For example, a user of client system 20 may use search engine website 200 to enter query terms and cause a search to be executed. At 605, at least one excerpt is extracted from a resource identified in step 605.

At 610, at least one term of interest is identified in the extracted excerpt. At 615, the term of interest is associated with a link. At 620, the excerpt containing the term of interest is displayed on a display of a client system, preferably as an abstract associated with the identified resource in search results. At 625, a second network search is automatically initiated by a user selecting the link associated with the term of interest (i.e., the active term) in the displayed abstract. The second network search is configured to search for resources relevant to the selected term of interest. At 630, search results for the second network search are displayed on the display of the client system.

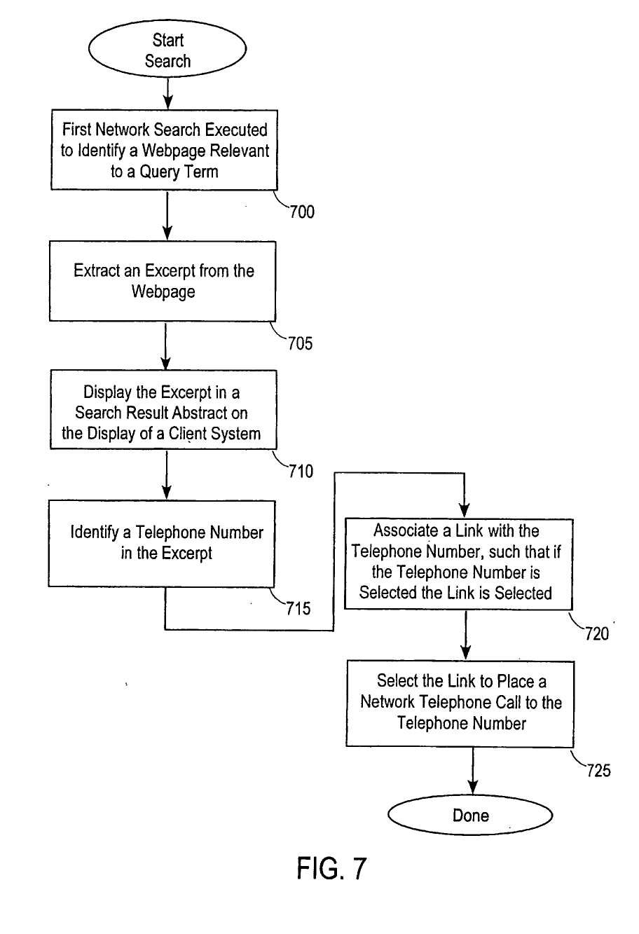

FIG. 7 is a high-level flow chart having steps for automatically placing a network telephone call according to one embodiment of the invention. The high-level flow chart shown in FIG. 7 is merely exemplary, and those of skill in the art will recognize various steps that might be added, deleted, and/or modified and are considered to be within the purview of the present invention. Therefore, the exemplary embodiment should not be viewed as limiting the invention as defined by the claims.

At 700, a first network search is performed to identify at least one resource relevant to a query term. For example, a user of client system 20 may use search engine website 200 to enter query terms and cause a search to be executed. At 705, at least one excerpt is extracted from an identified resource. At 710, the excerpt is displayed on a display of a client system, preferably in an abstract associated with the identified resource listed in search results.

At 715, a telephone number is identified in the excerpt. At 720, the identified telephone number is associated with a link. At 725, the link is selected by a user to cause a network telephone call to the telephone number to be automatically placed. In one embodiment the network telephone call comprises a voice over IP (VoIP) telephone call using techniques known to those skilled in the art.

Hardware Overview

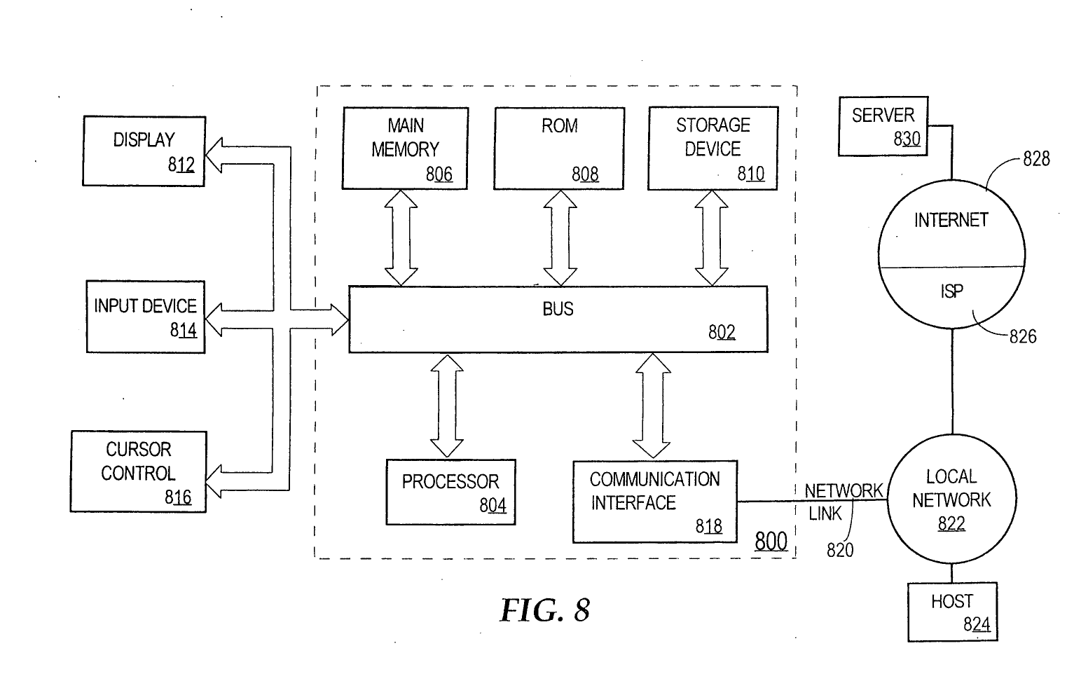

FIG. 8 is a block diagram that illustrates a computer system 800 upon which an embodiment of the invention may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 further includes a read only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

The invention is related to the use of computer system 800 for implementing the techniques described herein. According to one embodiment of the invention, those techniques are performed by computer system 800 in response to processor 804 executing one or more sequences of one or more instructions contained in main memory 806. Such instructions may be read into main memory 806 from another machine-readable medium, such as storage device 810. Execution of the sequences of instructions contained in main memory 806 causes processor 804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 800, various machine-readable media are involved, for example, in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are exemplary forms of carrier waves transporting the information.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution. In this manner, computer system 800 may obtain application code in the form of a carrier wave.

It should be appreciated that computer code for implementing aspects of the present invention can be C, C++, HTML, XML, Java, JavaScript, etc. code, or any other suitable scripting language (e.g., VBScript), or any other suitable programming language that can be executed on client system 20 and/or servers systems 40₁-40_{N} or compiled to execute on client system 20 and/or servers 40₁-40_{N}. In some embodiments, no code is downloaded to client system 20, and needed code is executed by a server, or code already present at client system 20 is executed.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for providing search results in response to a search query comprising the computer-implemented steps of:
based on the search query, identifying a resource relevant to the search query;
extracting an excerpt from the identified resource;
identifying a term of interest in the excerpt;
creating a link for the term of interest which, when selected, will cause a browser to retrieve a referral document; and
providing the excerpt as a portion of the search results of said search query.

2. The method of claim 1, wherein the search query includes at least one query term, and the step of identifying a term of interest in the excerpt comprises identifying a query term from the search query in the excerpt.

3. The method of claim 1, wherein the referral document is a document that is not the identified resource.

4. The method of claim 1, wherein the referral document is a cached version of the identified resource.

5. The method of claim 4, additionally comprising the step of:
inserting an anchor in the cached version of the identified resource;
wherein the link is associated with the anchor in the cached version of the identified resource.

6. The method of claim 5, wherein the step of inserting an anchor in the cached version of the identified resource comprises inserting an anchor at a location near a term of interest in the cached version of the identified resource.

7. The method of claim 1, wherein the search results are configured to display the term of interest in a conspicuous manner on a browser.

8. The method of claim 7, wherein the conspicuous manner is at least one of underlining the term of interest, double-underlining the term of interest, highlighting the term of interest, changing font of the term of interest and changing color of the term of interest.

9. A method for searching a document corpus comprising the computer-implemented steps of:
receiving a first search query from a client;
performing a first search of the document corpus to identify a matching resource for the first search query;
extracting an excerpt from the matching resource;
identifying a term of interest in the excerpt;
providing search results including the excerpt to the client;
upon receiving selection of an indicator associated with the term of interest in the excerpt, automatically performing a second search; and
providing search results of the second search to the client.

10. The method of claim 9, wherein the step of automatically performing a second search comprises automatically performing a search of the document corpus using the term of interest as a query term.

11. The method of claim 10, wherein the term of interest is not a query term of the first search query.

12. The method of claim 9, wherein the second search further includes at least one of a map search, a dictionary search, and a search of a company website.

13. The method of claim 12, wherein the search results of the second search includes at least one of directions to a place, a map, a definition of a word, and a document relevant to the term of interest.

14. The method of claim 9, wherein the term of interest includes at least one of a keyword, a category, a name, a trademark, a service mark, a title, an address, and a telephone number.

15. The method of claim 9, wherein the document corpus is the Internet.

16. A method for automatically placing a network telephone call comprising the computer-implemented steps of:
performing a first search to identify a resource relevant to a search query from a client;
extracting an excerpt from the identified resource;
identifying a telephone number in the excerpt;
associating the telephone number with a link; and
providing the excerpt as a portion of the search results for said search query to the client; and
upon receiving selection of the telephone number link from the client, automatically placing a network telephone call to the telephone number.

17. The method of claim 16, wherein the network telephone call is a voice over IP telephone call.

18. A machine-readable medium carrying one or more sequences of instructions which, when executed by one or more processors, causes the one or more processors to perform the method recited in claim 1.

19. A machine-readable medium carrying one or more sequences of instructions which, when executed by one or more processors, causes the one or more processors to perform the method recited in claim 2.

20. A machine-readable medium carrying one or more sequences of instructions which, when executed by one or more processors, causes the one or more processors to perform the method recited in claim 3.

21. A machine-readable medium carrying one or more sequences of instructions which, when executed by one or more processors, causes the one or more processors to perform the method recited in claim 4.

22. A machine-readable medium carrying one or more sequences of instructions which, when executed by one or more processors, causes the one or more processors to perform the method recited in claim 5.

23. A machine-readable medium carrying one or more sequences of instructions which, when executed by one or more processors, causes the one or more processors to perform the method recited in claim 6.

24. A machine-readable medium carrying one or more sequences of instructions which, when executed by one or more processors, causes the one or more processors to perform the method recited in claim 7.

25. A machine-readable medium carrying one or more sequences of instructions which, when executed by one or more processors, causes the one or more processors to perform the method recited in claim 8.

26. A machine-readable medium carrying one or more sequences of instructions which, when executed by one or more processors, causes the one or more processors to perform the method recited in claim 9.

27. A machine-readable medium carrying one or more sequences of instructions which, when executed by one or more processors, causes the one or more processors to perform the method recited in claim 10.

28. A machine-readable medium carrying one or more sequences of instructions which, when executed by one or more processors, causes the one or more processors to perform the method recited in claim 11.

29. A machine-readable medium carrying one or more sequences of instructions which, when executed by one or more processors, causes the one or more processors to perform the method recited in claim 12.

30. A machine-readable medium carrying one or more sequences of instructions which, when executed by one or more processors, causes the one or more processors to perform the method recited in claim 13.

31. A machine-readable medium carrying one or more sequences of instructions which, when executed by one or more processors, causes the one or more processors to perform the method recited in claim 14.

32. A machine-readable medium carrying one or more sequences of instructions which, when executed by one or more processors, causes the one or more processors to perform the method recited in claim 15.

33. A machine-readable medium carrying one or more sequences of instructions which, when executed by one or more processors, causes the one or more processors to perform the method recited in claim 16.

34. A machine-readable medium carrying one or more sequences of instructions which, when executed by one or more processors, causes the one or more processors to perform the method recited in claim 17.
